(19) United States
(12) Patent Application Publication
(10) Pub. No.: US 2012/0143546 A1
(43) Pub. Date: Jun. 7, 2012

(54) ELECTRICITY FEATURE IDENTIFICATION DEVICE AND METHOD THEREOF

(75) Inventor: Jing-Tian SUNG, Taichung City (TW)

(73) Assignee: INSTITUTE FOR INFORMATION INDUSTRY, Taipei (TW)

(21) Appl. No.: 13/038,515

(22) Filed: Mar. 2, 2011

(30) Foreign Application Priority Data
Dec. 2, 2010 (TW) 099141889

(51) Int. Cl. G06F 19/00

(52) U.S. Cl. 702/65

(57) ABSTRACT

An electricity feature identification device and a method thereof are provided. The device comprises a receiver, a storage, and a processor. The receiver is configured to receive an electricity signal continually. The processor is electrically connected to the storage and the receiver, and configured to sample the electricity signal to obtain a piece of testing electricity information, and store the testing electricity information in the storage. The processor is also configured to sample the electricity signal every sampling interval to individually obtain a piece of reference electricity information until the number of the reference electricity information is equal to a preset sample amount, and store the reference electricity information in the storage. Finally, the processor is configured to compute a statistical feature of the reference electricity information, and compare the testing electricity information with the statistical feature to obtain a comparison result.

### PRIORITY

This application claims priority to Taiwan Patent Application No. 099141889 filed on Dec. 2, 2010, which is hereby incorporated by reference in its entirety.

### FIELD

The present invention relates to an electricity feature identification device and a method thereof. More particularly, the electricity feature identification device and the method thereof of the present invention identifies whether an electricity signal is in a stable status and also a real-time electricity feature of the electricity signal according to a preset sample amount.

### BACKGROUND

With enhancement of the environmental protection and energy saving awareness worldwide, topics related to energy resources are gradually receiving more and more concern. The energy resource metering application is known as one of the most concerned applications related to energy resources. With conservative estimation, in the coming years, more than 200 millions of conventional electricity meters worldwide will be replaced by smart meters to satisfy the user's demands for real-time power-consumption information. Statistics of power-consumption information in the United States show that, use of about 39% of energy resources takes place in the housing environment. Therefore, it will become very important to provide the users with necessary power consumption information so as to alter the power-consuming behaviors of the users through deployment of the advanced metering infrastructure (AMI). Letting the users have a full knowledge of their own power-consuming behaviors will help to effectively achieve the objective of decreasing the power consumption.

One of the functions of the energy meters is to monitor usage statuses of electric appliances. Earlier, in order to monitor usage statuses of electric appliances and collect power consumption information of individual electric appliances, an electricity meter must be installed on each of the individual electric appliances. Then, non-invasive electrical circuit identification technologies have been developed, according to which only a single electricity meter may be installed in an electrical circuit. This can achieve the same monitoring effect by using a reduced number of electricity meters, thus saving the cost. Generally speaking, a non-invasive electrical circuit identification technology may be divided into an electric appliance training stage and an electric appliance identifying stage. The electric appliance training stage is to learn electricity features of an electric appliance, and the electric appliance identifying stage is to identify a real-time electricity feature of a received electricity signal.

In the electric appliance training stage, a desirable electricity feature can only be obtained when the electricity signal comes to a stable status. By a “stable” status, it means that the electricity signal varies to a small extent. In the conventional non-invasive electrical circuit identification technologies, determining whether an electricity signal of an electric appliance is stable is always depend on the user's experiences, and it is very likely to cause increase of the electric appliance training duration or even failure of the training Moreover, for most of the conventional non-invasive electrical circuit identification technologies, it is difficult to identify a real-time electricity feature in the electric appliance identifying stage; and for other conventional non-invasive electrical circuit identification technologies that can identify a real-time electricity feature, due to lack of a satisfactory pre-processing technology, an excessive amount of computations is required or too many useless packets have to be transmitted to lead to a decreased efficiency.

In view of this, an urgent need exists in the art to provide an electricity feature identification device and a method thereof that can effectively solve the problem of the conventional non-invasive electrical circuit identification technologies that the training duration is uncertain and it is impossible to efficiently identify a real-time electricity feature.

### SUMMARY

An objective of certain embodiments of the present invention is to provide an electricity feature identification device that can effectively solve the problem of the conventional non-invasive electrical circuit identification technologies that the training duration is uncertain and it is impossible to efficiently identify a real-time electricity feature.

To achieve the aforesaid objective, certain embodiments of the present invention provides an electricity feature identification device. The electricity feature identification device comprises a receiver, a storage and a processor. The receiver is configured to receive an electricity signal continuously. The processor is electrically connected to the storage and the receiver, and is configured to set a sampling interval and a preset sample amount of a stage. The processor can be further configured to sample the electricity signal to obtain a piece of testing electricity information of the stage and store the testing electricity information in the storage. The processor can also be configured to sample the electricity signal every sampling interval to individually obtain a piece of reference electricity information of the stage until a number of the pieces of reference electricity information is equal to the preset sample amount and store the pieces of reference electricity information in the storage. Finally, the processor can be configured to compute a statistical feature of the pieces of reference electricity information and compare the testing electricity information with the statistical feature to obtain a comparison result of the stage.

To achieve the aforesaid objective, certain embodiments of the present invention also provides an electricity feature identification method for a device. The device comprises a receiver, a storage and a processor. The method comprises the following steps of: (a) enabling the receiver to receive an electricity signal continuously; (b) enabling the processor to set a sampling interval and a preset sample amount of a stage; (c) enabling the processor to sample the electricity signal to obtain a piece of testing electricity information of the stage and store the testing electricity information in the storage; (d) enabling the processor to sample the electricity signal every sampling interval to individually obtain a piece of reference electricity information of the stage respectively until a number of the pieces of reference electricity information is equal to the preset sample amount and store the pieces of reference electricity information in the storage; (e) enabling the processor to compute a statistical feature of the pieces of reference electricity information; and (f) enabling the processor to compare the testing electricity information with the statistical feature to obtain a comparison result of the stage.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic view of an electricity feature identification device applied in an electrical circuit;

FIG. 2 is a schematic view of an electricity signal sampling of a first embodiment;

FIG. 3 is a schematic view of an electricity signal sampling of a second embodiment;

FIGS. 4A-4B are a flowchart of a third embodiment; and

FIG. 5 is a flowchart of a fourth embodiment.

### DETAILED DESCRIPTION

In the following description, an electricity feature identification device and a method thereof of the present invention will be explained with reference to example embodiments thereof. It shall be appreciated that, the present invention mainly relates to a device for identifying an electricity feature and a method thereof, so in the following example embodiments and the attached drawings, elements and steps not directly related to the present invention are omitted from depiction. Furthermore, in order to clearly disclose technical features of the present invention, the attached drawings are all depicted in a slightly exaggerative way. This is only for purpose of illustration rather than to limit the present invention, and the scope of this application shall be defined by the appended claims.

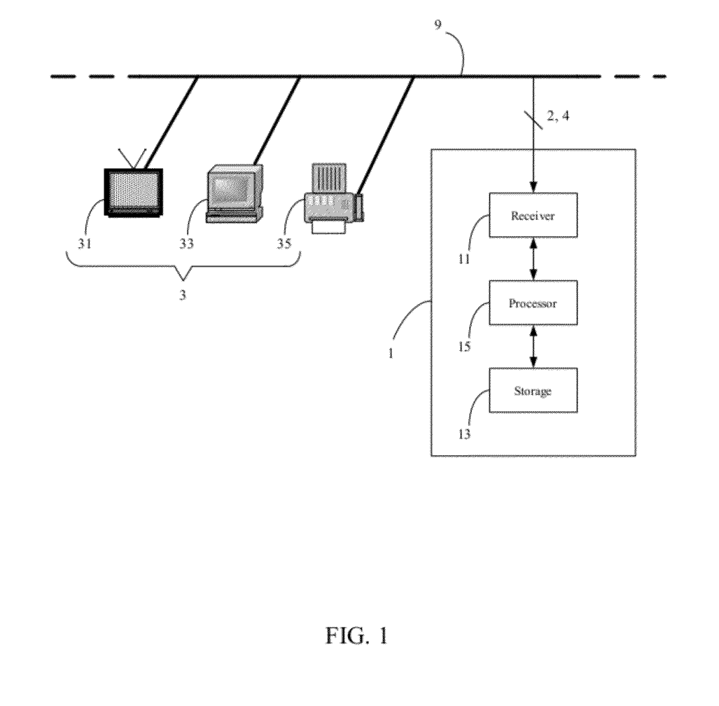

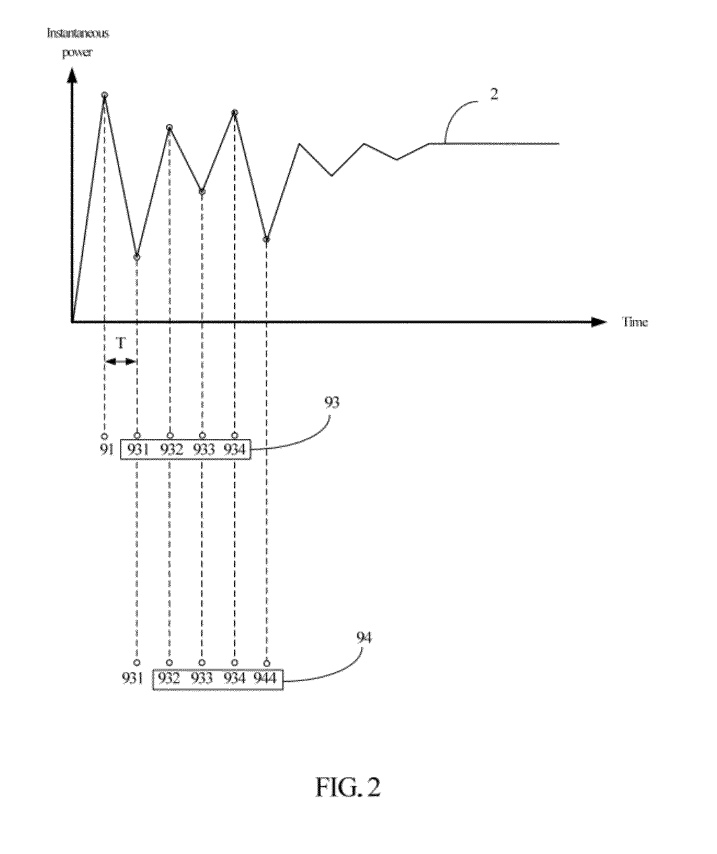

A first embodiment of the present invention is an electricity feature identification device 1, which will be described with reference to FIG. 1 and FIG. 2 together. FIG. 1 is a schematic view of the electricity feature identification device 1 applied in an electrical circuit 9, and FIG. 2 is a schematic view of an electricity signal sampling of the first embodiment. As shown in FIG. 1, the electricity feature identification device 1 comprises a receiver 11, a storage 13 and a processor 15. The processor 15 is electrically connected to the storage 13 and the receiver 11. The receiver 11 is electrically connected to the electrical circuit 9, and is configured to receive an electricity signal 2 on the electrical circuit 9 continuously. The electricity signal 2 is from an electric appliance group 3 electrically connected to the electrical circuit 9.

In this embodiment, how the electricity feature identification device 1 determines in an electric appliance training stage whether the electricity signal 2 is in a stable status so as to further identify an electricity feature of an electric appliance will be primarily elucidated. In the electric appliance training stage, the electricity feature identification device 1 will train an electric appliance 31, an electric appliance 33 and an electric appliance 35 respectively to learn electricity features of the individual electric appliances of the electric appliance group 3.

Taking training of the electric appliance 31 as an example, when the electric appliance 31 is turned on, the receiver 11 receives the electricity signal 2 of the electric appliance 31 from the electrical circuit 9 continuously. After the electricity signal 2 of the electric appliance 31 is received, the processor 15 sets a sampling interval T and a preset sample amount of a first stage. The sampling interval T is used to determine a time interval at which the electricity signal 2 is sampled, and the preset sample amount is used to determine how many times the electricity signal 2 is continuously sampled at the sampling interval T. For purpose of describing this embodiment more clearly, the preset sample amount of the first stage will be assumed to be four in the following description; however, this is not intended to limit the present invention.

As shown in FIG. 2, firstly, the processor 15 samples the electricity signal 2 of the electric appliance 31 to obtain a piece of testing electricity information 91 of the first stage, and stores the testing electricity information 91 in the storage 13. It shall be appreciated that, in other embodiments of the present invention, the testing electricity information 91 may also be a plurality of electricity information retrieved by sampling the electricity signal 2 of the electric appliance 31 several times at the sampling interval T. Upon storing the testing electricity information 91 in the storage 13, the processor 15 samples the electricity signal 2 of the electric appliance 31 every sampling interval T to individual obtain a piece of reference electricity information of the first stage respectively until a number of the reference electricity information is equal to the preset sample amount. In other words, a piece of reference electricity information is obtained per sampling, and this is repeated until four pieces of reference electricity information are obtained. The processor 15 thus obtains a plurality of (i.e., four) pieces of reference electricity information 93 in the first stage, and stores the pieces of reference electricity information 93 in the storage 13. The pieces of reference electricity information 93 comprise a piece of reference electricity information 931, a piece of reference electricity information 932, a piece of reference electricity information 933 and a piece of reference electricity information 934.

Next, the processor 15 computes a statistical feature of the pieces of reference electricity information 93, and compares the testing electricity information 91 with the statistical feature of the pieces of reference electricity information 93 to obtain a comparison result. For example, the processor 15 can determine whether the testing electricity information 91 falls within a probability distribution range defined by the statistical feature. The probability distribution range may be defined according to an average value, a variance or other statistical parameters of the statistical feature, but is not limited to what disclosed herein. The comparison result of the first stage thus obtained, together with a comparison result obtained from the subsequent process, will serve as a basis for determining whether the training of the electric appliance 31 has been completed.

After obtaining the aforesaid comparison result, the processor 15 chooses the piece of reference electricity information 931 from the pieces of reference electricity information 93 of the first stage, and sets the reference electricity information 931 as a piece of testing electricity information of a second stage. It shall be appreciated that, in other embodiments of the present invention, the processor 15 may choose multiple pieces of reference electricity information from the pieces of reference electricity information 93 of the first stage simultaneously, and sets the multiple pieces of reference electricity information as multiple pieces of testing electricity information of the second stage.

Next, the processor 15 continues to sample the electricity signal 2 of the electric appliance 31 to obtain a piece of additional electricity information 944, and sets the additional electricity information 944 and the reference electricity information that are not chosen in the first stage (i.e., the reference electricity information 932, the reference electricity information 933 and the reference electricity information 934) as a plurality of pieces of reference electricity information 94 of the second stage. In other words, the pieces of reference electricity information 94 of the second stage comprise the reference electricity information 932, the reference electricity information 933, the reference electricity information 934 and the additional electricity information 944. It shall be appreciated that, in this embodiment, because the processor 15 chooses only one piece of reference electricity information of the first stage as the testing electricity information of the second stage, the processor 15 has to further sample the electricity signal 2 of the electric appliance 31 once for use as the additional electricity information of the second stage. If the processor 15 has chosen multiple pieces of reference electricity information of the first stage as the testing electricity information of the second stage, then the processor 15 has to further sample the electricity signal 2 of the electric appliance 31 with the same number of times for use as multiple pieces of additional electricity information.

Next, the processor 15 computes a statistical feature of the pieces of reference electricity information 94 of the second stage. Similarly, the processor 15 determines whether the testing electricity information (i.e., the reference electricity information 931) of the second stage falls within a probability distribution range defined by the statistical feature of the pieces of reference electricity information 94. The probability distribution range may be defined according to an average value, a variance or other statistical parameters of the statistical feature, but is not limited to what disclosed herein.

Finally, the processor 15 determines whether the pieces of reference electricity information 94 of the second stage are in a stable status according to the comparison result of the first stage and the comparison result of the second stage. A stable electricity feature and an unstable electricity feature have different statistical features from each other, so when both the comparison results of the first stage and the second stage show that the testing electricity information falls within the probability distribution range defined by the statistical feature of the reference electricity information, it can be reasonably inferred that the electric appliance 31 has been in a stable status. Then, the processor 15 can set the pieces of reference electricity information 94 of the second stage as the electricity feature of the electric appliance 31. At this point, the training of the electric appliance 31 by the electricity feature identification device 1 of the first embodiment is completed.

It shall be appreciated that, in other embodiments, it can be readily inferred by those of ordinary skill in the art that the electricity feature identification device 1 of the present invention may determine whether the electric appliance 3 is in a stable status according to comparison results of more stages, but is not merely limited to the two stages disclosed in this embodiment.

Through arrangement and operations of the first embodiment, the electricity feature identification device 1 of the present invention can determine whether an electric appliance has been in a stable status by comparing the testing electricity information with the statistical feature of the reference electricity information. Accordingly, the problem of the prior art that determining whether an electricity signal of an individual electric appliance is stable according to the user's experience tends to cause inconvenience in the user's operation or uncertainty in the electric appliance training can be effectively solved.

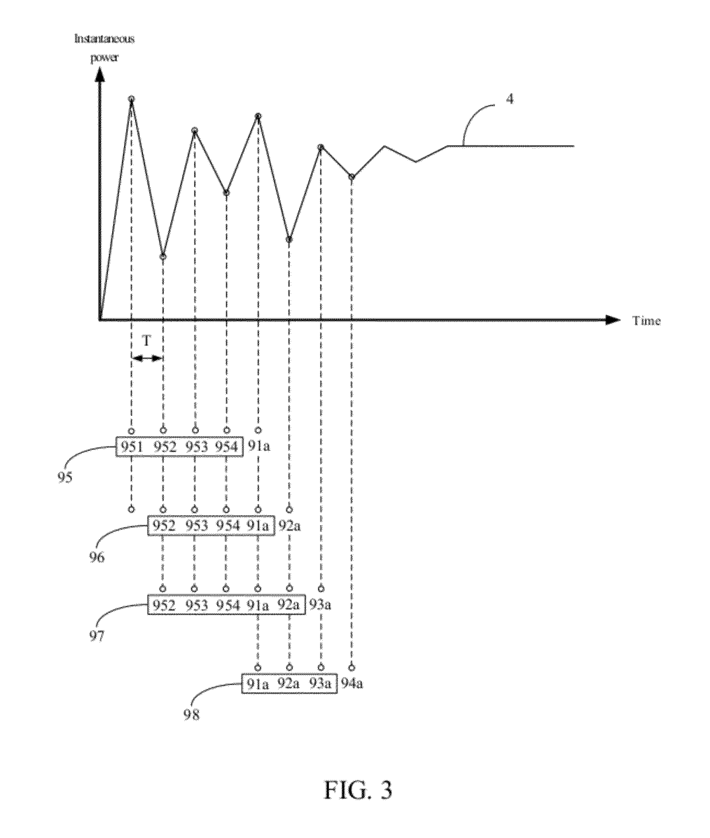

A second embodiment of the present invention is also an electricity feature identification device 1, which will be described with reference to FIG. 1 and FIG. 3 together. FIG. 3 is a schematic view of an electricity signal sampling of the second embodiment. In this embodiment, how the electricity feature identification device 1 identifies a real-time electricity feature of an electricity signal 4 in an electric appliance identifying stage will be primarily elucidated. After training of all the electric appliances of the electric appliance group 3 is completed, the electricity feature identification device 1 is able to monitor the electric appliance group 3 on the electrical circuit 9. In the monitoring stage, the electricity feature identification device 1 receives the electricity signal 4 from the electrical circuit 9 continuously, and identifies the electricity feature of the electricity signal 4 continuously to provide a piece of real-time electricity information of the electric appliance group 3.

After receiving the electricity signal 4 from the electrical circuit 9, the processor 15 sets a sampling interval T and a preset sample amount of a first stage. The sampling interval is used to determine a time interval at which the electricity signal 4 is sampled, and the preset sample amount is used to determine how many times the electricity signal 4 is continuously sampled at the sampling interval. To describe this embodiment more clearly, the preset sample amount of the first stage will be assumed to be four in the following description; however, this is not intended to limit the present invention.

Firstly, the processor 15 samples the electricity signal 4 at the sampling interval T to individually obtain a piece of reference electricity information of the first stage until a number of the pieces of reference electricity information is equal to the preset sample amount (i.e., four). In other words, a piece of reference electricity information is obtained per sampling, and this is repeated until four pieces of reference electricity information are obtained. The processor 15 thus obtains a plurality of (i.e., four) pieces of reference electricity information 95 in the first stage, and stores the pieces of reference electricity information 95 in the storage 13. The pieces of reference electricity information 95 comprise a piece of reference electricity information 951, a piece of reference electricity information 952, a piece of reference electricity information 953 and a piece of reference electricity information 954. Upon storing the pieces of reference electricity information 95 in the storage 13, the processor 15 samples the electricity signal 4 to obtain a piece of testing electricity information 91a of a first stage and stores the testing electricity information 91a in the storage 13.

Next, the processor 15 computes a statistical feature of the pieces of reference electricity information 95, and compares the testing electricity information 91a with the statistical feature to obtain a comparison result of the first stage. For example, the processor 15 can determine whether the testing electricity information 91 falls within a probability distribution range defined by the statistical feature so as to identify a real-time electricity feature of the electricity signal 4. Then according to the real-time electricity feature, the electricity feature identification device 1 can determine whether such cases as turning on of a new electric appliance, turning off of an electric appliance or abnormal conditions of an electric appliance occur. The probability distribution range may be defined according to an average value, a variance or other statistical parameters of the statistical feature, but is not limited to what disclosed herein.

By adjusting the preset sample amount dynamically, the false probability of picking out an electricity feature is effectively reduced. The processor 15 can further set a preset sample amount of a second stage according to a difference in the probability distribution range defined by the statistical feature within which the testing electricity information 91a falls. In other words, the processor 15 adjusts the preset sample amount according to the comparison result of the first stage. Depending on different conditions, the preset sample amount of the second stage may be greater than, equal to or smaller than the preset sample amount of the first stage.

There exists a plurality of pieces of reference electricity information 96 in the second stage, the number of which is equal to the preset sample amount of the second stage. The processor 15 samples the electricity signal 4 again to obtain a piece of testing electricity information 92a of the second stage. Then, the processor 15 computes a statistical feature of the pieces of reference electricity information 96 of the second stage, and compares the testing electricity information 92a with the statistical feature of the second stage to identify another real-time electricity feature of the electricity signal 4 again. Repeating aforesaid procedure by the processor 15, the electricity feature identification device 1 can know a real-time electricity feature of the electricity signal 4 of the electrical circuit 9 at any time and determine whether there is a need to transmit or compute the electricity feature so as to effectively inform the user the real-time electricity feature.

In order to elucidate more clearly how to set the preset sample amount of the second stage according to the difference in the probability distribution range defined by the statistical feature within which the testing electricity information falls, an example in which a first variance and a second variance define the probability distribution range of the statistical feature will be described hereinafter. The second variance is greater than the first variance.

As shown in FIG. 3, if the testing electricity information 91a falls within a probability range of the statistical feature of the pieces of reference electricity information 95 and the probability range is greater than the first variance but smaller than the second variance, it means that the testing electricity information 91a is a feature that is already known. Then, the processor 15 sets the preset sample amount of the next stage to be the same as the preset sample amount of the present stage (i.e., the preset sample amount of the second stage is equal to the preset sample amount of the first stage, which is four).

Next, the processor 15 sets the reference electricity information 952, 953, 954 and the testing electricity information 91a as a plurality of pieces of reference electricity information 96 of the second stage. The number of the pieces of reference electricity information 96 is equal to the preset sample amount of the second stage. At a next time point (after one sampling interval), the processor 15 samples the electricity signal 4 again to obtain a piece of testing electricity information 92a. Then, the processor 15 computes a statistical feature of the pieces of reference electricity information 96 of the second stage, and compares the statistical feature with the testing electricity information 92a to obtain a comparison result of the second stage. Here, it is assumed that, according to the comparison result of the second stage, the testing electricity information 92a falls within a probability distribution range (e.g., greater than the second variance), which means that the testing electricity information 92a may be a feature of a same electric appliance. Thus, the processor 15 sets the preset sample amount of a next stage (i.e., a third stage) to be greater than the preset sample amount of the present stage (i.e., the second stage).

Next, the processor 15 sets the reference electricity information 952, 953, 954 and the testing electricity information 91a, 92a as a plurality of pieces of reference electricity information 97 of the third stage. The number of the pieces of reference electricity information 97 is equal to the preset sample amount of the third stage (e.g. five). At a further next time point, the processor 15 samples the electricity signal 4 again to obtain a piece of testing electricity information 93a. Then, the processor 15 computes a statistical feature of the pieces of reference electricity information 97 of the third stage, and compares the statistical feature with the testing electricity information 93a to obtain a comparison result of the third stage. If the comparison result of the third stage is that the testing electricity information 93a falls within a probability distribution range (e.g., smaller than the first variance), then it means that the testing electricity information 93a may be a feature of a new electric appliance. Thus, the processor 15 sets the preset sample amount of a next stage (i.e., a fourth stage) to be smaller than the preset sample amount of the present stage (i.e., the third stage). In the next stage (i.e., the fourth stage), the processor 15 sets the testing electricity information 91a, 92a, 93a as a plurality of pieces of reference electricity information 98 of the fourth stage. The number of the pieces of reference electricity information 98 is equal to the preset sample amount of the fourth stage (e.g., three).

It shall be appreciated that, the above description is only for purpose of illustrating the embodiments of the present invention more clearly, but is not intended to limit the present invention. Instead of being merely limited to the example shown in FIG. 3, those of ordinary skill in the art can readily use other parameters to define the probability distribution range of the statistical feature and readily set the preset sample amount of a next stage.

Through arrangement and operations of the second embodiment, the electricity feature identification device 1 of the present invention can know a real-time electricity feature of the electricity signal 4 of the electrical circuit 9 at any time by comparing the testing electricity information with the statistical feature of the reference electricity information. Accordingly, the problem of the prior art that an excessive amount of computations is required or too many useless packets have to be transmitted to lead to a decreased efficiency can be effectively solved.

A third embodiment of the present invention is an electricity feature identification method for use in a device. The device comprises a receiver, a storage and a processor. The receiver, the storage and the processor may be the receiver 11, the storage 13 and the processor 15 of the first embodiment respectively. In other words, the device may be the electricity feature identification device 1 of the first embodiment.

Furthermore, the electricity feature identification method described in the third embodiment may be implemented by a computer program product. When the computer program product is loaded into the device and a plurality of instructions comprised in the computer program product is executed, the electricity feature identification method described in the third embodiment can be accomplished. The aforesaid computer program product may be stored in a tangible machine-readable medium, such as a read only memory (ROM), a flash memory, a floppy disk, a hard disk, a compact disk (CD), a mobile disk, a magnetic tape, a database accessible to networks, or any other storage media with the same function and well known to those skilled in the art.

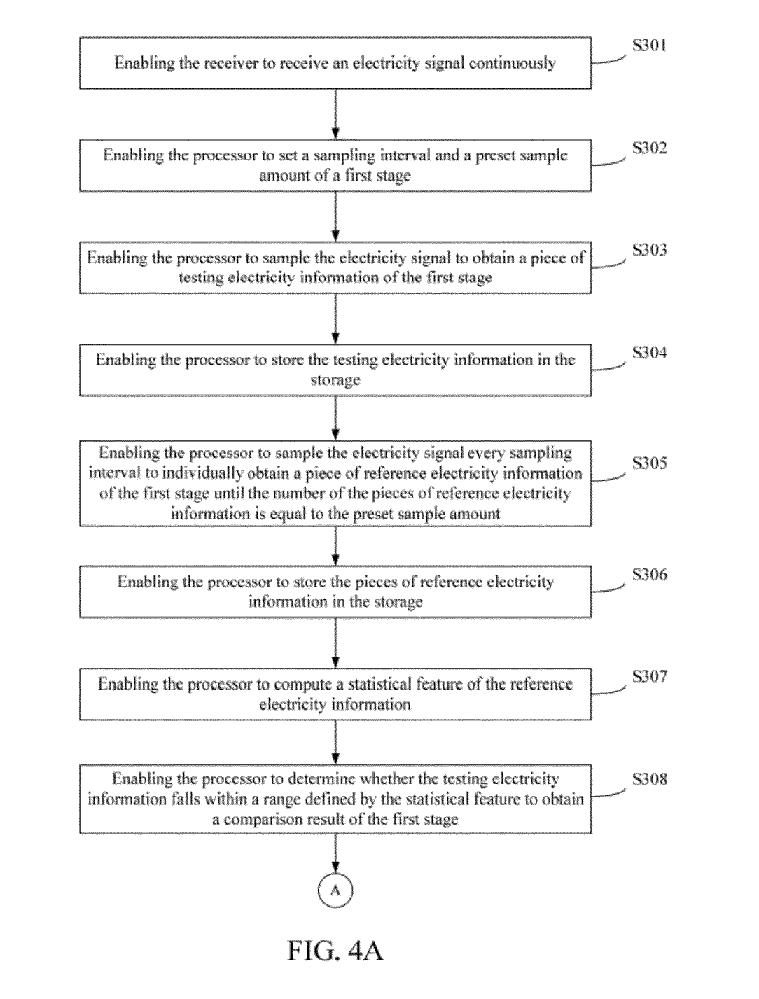

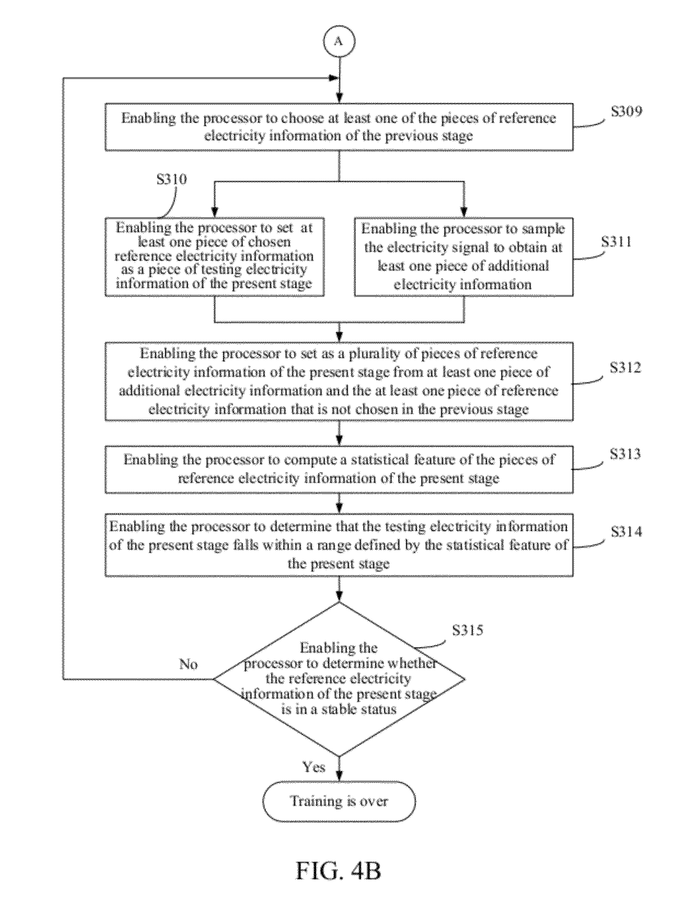

FIGS. 4A-4B are a flowchart depicting the third embodiment. Firstly, step S301 is executed to enable the receiver to receive an electricity signal continuously. Next, step S302 is executed to enable the processor to set a sampling interval and a preset sample amount of a first stage. Step S303 is executed to enable the processor to sample the electricity signal to obtain a piece of testing electricity information of the first stage, and then step S304 is executed to enable the processor to store the testing electricity information in the storage. Subsequent to the step S303, step S305 is executed to enable the processor to sample the electricity signal every sampling interval to individually obtain a piece of reference electricity information of the first stage until a number of the pieces of reference electricity information is equal to the preset sample amount. Then, step S306 is executed to enable the processor to store the pieces of reference electricity information in the storage. Next, step S307 is executed to enable the processor to compute a statistical feature of the pieces of reference electricity information, and step S308 is executed to enable the processor to determine whether the testing electricity information falls within a range defined by the statistical feature so as to obtain a comparison result of the first stage.

After the step S308, step S309 is executed to enable the processor to choose at least one of the pieces of reference electricity information of the previous stage. After the step S309, step S310 is executed to enable the processor to set the chosen at least one piece of reference electricity information as a piece of testing electricity information of the present stage, and step S311 is executed to enable the processor to sample the electricity signal to obtain at least one piece of additional electricity information. Subsequent to the step S310 and the step S311, step S312 is executed to enable the processor to set, as a plurality of pieces of reference electricity information of the present stage, the at least one piece of additional electricity information and the at least one piece of reference electricity information that is not chosen in the previous stage. After the step S312, step S313 is executed to enable the processor to compute a statistical feature of the pieces of reference electricity information of the present stage. After the step S313, step S314 is executed to enable the processor to determine whether the testing electricity information of the present stage falls within a range defined by the statistical feature of the present stage.

After the step S314, step S315 is executed to enable the processor to determine whether the reference electricity information of the present stage is in a stable status. The step S315 is to determine whether the reference electricity information is in a stable status according to the comparison result obtained in the present stage and the comparison result obtained in the previous stage. If the determination result is “yes”, then the training of the electric appliance is over. Otherwise, if the determination result is “no”, then the method returns to the step S309 for a recursive process.

In addition to the aforesaid steps, the third embodiment can also execute all the operations and functions set forth in the first embodiment. How the third embodiment executes these operations and functions will be readily appreciated by those of ordinary skill in the art based on the explanation of the first embodiment, and thus will not be further described herein.

As can be known from the description of the flow process of the third embodiment, the electricity feature identification method of the present invention can determine whether an electric appliance has been in a stable status by comparing the testing electricity information with the statistical feature of the reference electricity information. Accordingly, the problem of the prior art that determining whether an electricity signal of an individual electric appliance is stable according to the user's experience tends to cause inconvenience in the user's operation or uncertainty in the electric appliance learning can be effectively solved.

A fourth embodiment of the present invention is also an electricity feature identification method for use in a device. The device comprises a receiver, a storage and a processor. The receiver, the storage and the processor may be the receiver 11, the storage 13 and the processor 15 of the first embodiment respectively. In other words, the device may be the electricity feature identification device 1 of the first embodiment.

Furthermore, the electricity feature identification method described in the fourth embodiment may also be implemented by a computer program product. When the computer program product is loaded into the device and a plurality of instructions comprised in the computer program product is executed, the electricity feature identification method described in the fourth embodiment can be accomplished. The aforesaid computer program product may be stored in a tangible machine-readable medium, such as a read only memory (ROM), a flash memory, a floppy disk, a hard disk, a compact disk (CD), a mobile disk, a magnetic tape, a database accessible to networks, or any other storage media with the same function and well known to those skilled in the art.

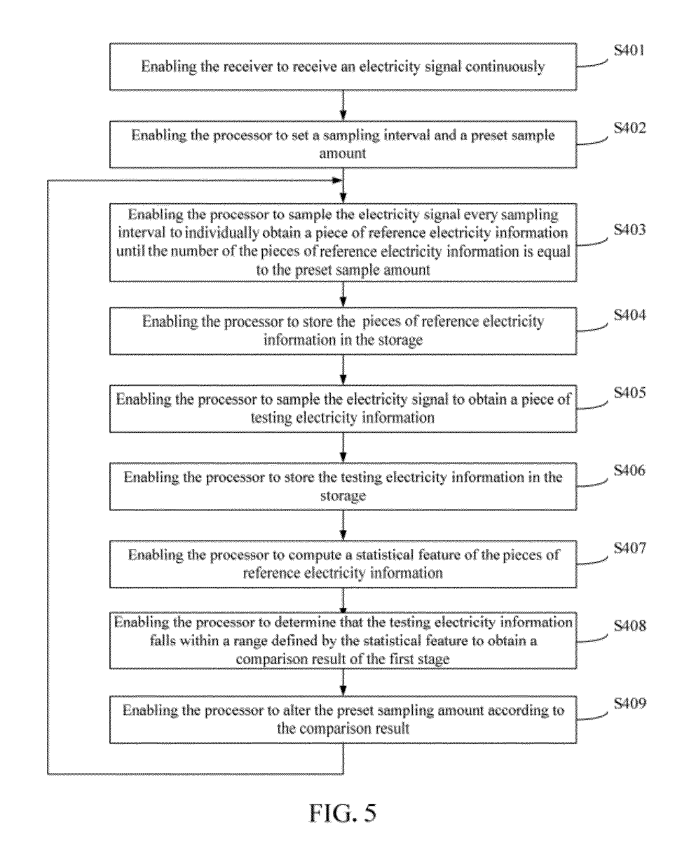

FIG. 5 is a flowchart depicting the fourth embodiment. Firstly, step S401 is executed to enable the receiver to receive an electricity signal continuously. Next, step S402 is executed to enable the processor to set a sampling interval and a preset sample amount. Subsequent to the step S402, step S403 is executed to enable the processor to sample the electricity signal at the sampling interval to obtain a piece of reference electricity information respectively until a number of the pieces of reference electricity information is equal to the preset sample amount, and step S404 is executed to enable the processor to store the pieces of reference electricity information in the storage. After the step S403, step S405 is executed to enable the processor to sample the electricity signal to obtain a piece of testing electricity information, and step S406 is executed to enable the processor to store the testing electricity information in the storage. Step S407 is executed to enable the processor to compute a statistical feature of the pieces of reference electricity information. Thereafter, step S408 is executed to enable the processor to determine whether the testing electricity information falls within a range defined by the statistical feature so as to obtain a comparison result of the first stage. Step S409 is executed to enable the processor to alter the preset sampling amount according to the comparison result. Then, the method returns to the step S403 for recursive process.

In addition to the aforesaid steps, the fourth embodiment can also execute all the operations and functions set forth in the second embodiment. How the fourth embodiment executes these operations and functions will be readily appreciated by those of ordinary skill in the art based on the explanation of the second embodiment, and thus will not be further described herein.

Through arrangement and operations of the fourth embodiment, the electricity feature identification method of the present invention can know a real-time electricity feature of the electricity signal at any time by comparing the testing electricity information with the statistical feature of the reference electricity information. Accordingly, the problem of the prior art that an excessive amount of computations is required or too many useless packets have to be transmitted to lead to a decreased efficiency can be effectively solved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electricity feature identification device, comprising:
a receiver, being configured to receive an electricity signal continuously;
a storage; and
a processor, being electrically connected to the storage and the receiver and configured to:
set a sampling interval and a preset sample amount of a first stage,
sample the electricity signal to obtain a piece of testing electricity information of the first stage and store the testing electricity information in the storage,
sample the electricity signal every sampling interval to individually obtain a piece of reference electricity information of the first stage until a number of the pieces of reference electricity information is equal to the preset sample amount and store the pieces of reference electricity information in the storage,
compute a statistical feature of the pieces of reference electricity information, and
compare the testing electricity information with the statistical feature to obtain a comparison result of the first stage.

2. The device as claimed in claim 1, wherein the processor is configured to obtain the pieces of reference electricity information after obtaining the testing electricity information.

3. The device as claimed in claim 2, wherein the comparison result of the first stage is the testing electricity information falling within a probability distribution range defined by the statistical feature.

4. The device as claimed in claim 3, wherein the processor is further configured to:
choose at least one of the pieces of reference electricity information of the first stage,
set the at least one piece of chosen reference electricity information as a piece of testing electricity information of a second stage,
sample the electricity signal to obtain at least one piece of additional electricity information,
set the at least one piece of additional electricity information and the at least one piece of reference electricity information that is not chosen in the first stage as a plurality of pieces of reference electricity information of the second stage,
compute a statistical feature of the pieces of reference electricity information of the second stage,
determine whether the testing electricity information of the second stage falls within a probability distribution range defined by the statistical feature of the second stage, and
determine the reference electricity information of the second stage being in a stable status.

5. The device as claimed in claim 1, wherein the processor obtains the pieces of reference electricity information before obtaining the testing electricity information.

6. The device as claimed in claim 5, wherein the comparison result of the first stage is the testing electricity information falling within a probability distribution range defined by the statistical feature, and the processor further sets a preset sample amount of a second stage to be equal to the preset sample amount of the first stage.

7. The device as claimed in claim 5, wherein the comparison result of the first stage is the testing electricity information falling within a probability distribution range defined by the statistical feature, and the processor further sets a preset sample amount of a second stage to be greater than the preset sample amount of the first stage.

8. The device as claimed in claim 7, wherein the preset sample amount of the second stage is smaller than or equal to a maximum preset sample amount.

9. The device as claimed in claim 5, wherein the comparison result of the first stage is the testing electricity information falling within a probability distribution range defined by the statistical feature, and the processor further sets a preset sample amount of a second stage to be smaller than the preset sample amount of the first stage.

10. The device as claimed in claim 9, wherein the preset sample amount of the second stage is greater than or equal to a minimum preset sample amount.

11. An electricity feature identification method for use in a device, the device comprising a receiver, a storage and a processor, the method comprising the steps of:
(a) enabling the receiver to receive an electricity signal continuously;
(b) enabling the processor to set a sampling interval and a preset sample amount of a first stage;
(c) enabling the processor to sample the electricity signal to obtain a piece of testing electricity information of the first stage;
(d) enabling the processor to store the testing electricity information in the storage;
(e) enabling the processor to sample the electricity signal every sampling interval to individually obtain a piece of reference electricity information of the first stage until a number of the pieces of reference electricity information is equal to the preset sample amount;
(f) enabling the processor to store the pieces of reference electricity information in the storage;
(g) enabling the processor to compute a statistical feature of the pieces of reference electricity information; and
(h) enabling the processor to compare the testing electricity information with the statistical feature to obtain a comparison result of the first stage.

12. The method as claimed in claim 11, wherein the step (e) is executed after the step (c).

13. The method as claimed in claim 12, wherein the comparison result of the first stage is the testing electricity information falling within a probability distribution range defined by the statistical feature.

14. The method as claimed in claim 13, further comprising the steps of:
(i) after the step (h), enabling the processor to choose at least one of the pieces of reference electricity information of the first stage;
(j) after the step (i), enabling the processor to set the at least one piece of chosen reference electricity information as a piece of testing electricity information of a second stage;
(k) after the step (i), enabling the processor to sample the electricity signal to obtain at least one piece of additional electricity information;
(l) after the step (k), enabling the processor to set the at least one piece of additional electricity information and the at least one piece of reference electricity information that is not chosen in the first stage as a plurality of pieces of reference electricity information of the second stage;
(m) after the step (l), enabling the processor to compute a statistical feature of the pieces of reference electricity information of the second stage;
(n) after the step (m), enabling the processor to determine the testing electricity information of the second stage falling within a range defined by the statistical feature of the second stage; and
(o) after the step (n), enabling the processor to determine the reference electricity information of the second stage being in a stable status.

15. The method as claimed in claim 11, wherein the step (c) is executed after the step (e).

16. The method as claimed in claim 15, wherein the comparison result of the first stage is the testing electricity information falling within a probability distribution range defined by the statistical feature, and the method further comprises the step of:
(i) after the step (h), enabling the processor to set a preset sample amount of a second stage to be equal to the preset sample amount of the first stage.

17. The method as claimed in claim 15, wherein the comparison result of the first stage is the testing electricity information falling within a probability distribution range defined by the statistical feature, and the method further comprises the step of:
(i) after the step (h), enabling the processor to set a preset sample amount of a second stage to be greater than the preset sample amount of the first stage.

18. The method as claimed in claim 17, wherein the preset sample amount of the second stage is smaller than or equal to a maximum preset sample amount.

19. The method as claimed in claim 15, wherein the comparison result of the first stage is the testing electricity information falling within a probability distribution range defined by the statistical feature, and the method further comprises the step of:
(i) after the step (h), enabling the processor to set a preset sample amount of a second stage to be smaller than the preset sample amount of the first stage.

20. The method as claimed in claim 17, wherein the preset sample amount of the second stage is greater than or equal to a minimum preset sample amount.
